(19) United States
(12) Patent Application Publication
(10) Pub. No.: US 2008/0125218 A1
(43) Pub. Date: May 29, 2008

(54) Method of use for a commercially available portable virtual reality system

(76) Inventor: Kelly James Collins, Johnstown, NY (US)

Correspondence Address: DELAIN & LIEBERT, PLLC, 400 CLIFTON CORPORATE PARKWAY, SUITE 470, CLIFTON PARK, NY, 12065, US

(21) Appl. No.: 11/533,750

(22) Filed: Sep. 20, 2006

(51) Int. Cl. G06F 17/00

(52) U.S. Cl. 463/31

(57) ABSTRACT

The present invention comprises a method of use for a commercially available portable virtual reality device comprising use of a portable virtual reality device for entertainment by one or more persons who are in a mentally and physically sedentary setting; and use of a virtual reality scenario that is related to but more stimulating than a person's physical setting.

### BACKGROUND OF THE INVENTION

1. Field of the Invention

The field of the invention is entertainment, more specifically entertainment utilizing a portable virtual reality device or mechanism while the user engages in a sedentary physical and mental activity. The invention may also be used for the purpose of crowd control, more specifically controlling crowds who are waiting for an event such as an amusement park ride.

2. Description of Related Art

Virtual reality devices or mechanisms are well known in the art. They are used to visualize everything from microscopic surgical manipulations to fighting fantasy space wars.

There are many uses of virtual reality systems in the art. These include such uses as visualizing surgical procedures, playing video games, and presenting a user with a scenario in a skill the user wishes to develop the reflexes to master such as a skill that is too dangerous or too expensive to actually engage in outside of the virtual reality until the skill is mastered.

U.S. Pat. No. 5,563,988 teaches an electronic system for integrating a user's moving image into a computer-generated pictorial environment, and allowing the user to interact with the environment and objects therein. The environment is rendered on a screen display in a manner that simulates three dimensions, including respect for occlusion relationships among the user and objects in the environment. The resulting image, which changes as the user gestures and interacts with the environment, is projected onto a large screen that the user faces. The environment includes a series of mobile entities, or “agents,” which respond to one or more of the user's changing position, gestures and voice, exhibiting context-dependent behavior that appears semi-intelligent.

U.S. Pat. No. 5,629,732 teaches that, in a multimedia application where movie events are distributed on an on-demand basis, a multimedia server serves a subscriber requesting a movie event through either a high-demand process or a low-demand process. In a low demand process, a data stream representative of the movie is exclusively provided to the subscriber in accordance with a double-buffering technique. The server may switch many low-demand processes serving the same movie event into a high-demand process to effectively utilize limited resources. In the high-demand process, high-demand pointers are launched periodically and are associated with data streams representative of the movie event having different start times. Each data stream associated with a high-demand pointer may be shared by an unlimited number of subscribers. Service alterations of the movie including fast-forwarding, rewinding, and restarting after a pause are achieved by way pointer-hopping.

U.S. Pat. No. 5,765,314 relates to a sensory interactive multi media entertainment theater for presenting innovative, sensory oriented interactive productions combining live theater and motion picture technology in a 360.degree. visual effects theater building. The present invention relates to a theater comprising a circular arena having a 360 degree media surface and tiered seating on preferably hydraulic platforms that can be raised or lowered automatically. Seats may rotate by sections and follow the action of the show to ensure that the audience witnesses every aspect of the production. The individual seats may rotate via automated control and preferably include surround-sound speakers built into the headrests. Appliances built into the seats, armrests and nearby flooring can create a changing thematic environment to complete the sensory experience. A center stage along with stage runners may be hydraulically raised or lowered depending upon the production.

U.S. Pat. No. 5,795,228 teaches an interactive computer-based entertainment system interacts with a user and presents to the user an interactive show comprising audio, video images and computer-generated graphical images. The entertainment system comprises a user interface, a database, a show controller and an activity server. The user interface receives user input signals indicative of user input actions, and further presents user output signals to the user. The user output signals are indicative of the audio, video and computer graphical images generated by output devices. The database receives the user input signals and generates in dependence thereupon database signals which are indicative of an informational record of the user. The informational record is indicative of user characteristics which serve to uniquely identify the user. The show controller generates a first set of show control signals indicative of the audio, the video images and the computer-generated graphical images of the show. The activity server receives the user input signals, the database signals and the show control signals, and generates in dependence thereupon activity server signals for directing presentation of the user output signals by the user interface. The activity server signals are presented to the show controller and the show controller generates in dependence thereupon a second set of show control signals indicative of the audio, the video images and the computer-generated graphical images of the show which are adjusted in accordance with the user input actions.

U.S. Pat. No. 6,007,338 teaches a realistic roller coaster simulator having one or more passenger seats equipped with a safety harness and mounted for 360 degree rotational movement along at least two axes for simulating the motion of a roller coaster. A controller is provided for controlling and coordinating the motion of the simulator with a simulation controller which generates to the passenger synchronized audio and visual effects which would be experienced by a passenger on a roller coaster of a predetermined design. Linked to the simulator is a design station where a passenger can design his or her own roller coaster. Upon entering the simulator station, the passenger's design can be accessed from memory and selected for simulation on the simulator vehicle. Upon initiation of the simulation, the passenger can experience in real time the visual, motive, audible and other effects (such as wind, heat, cold, water, etc.) of the simulated roller coaster ride which the passenger has designed.

U.S. Pat. No. 6,066,075 teaches an apparatus and method for providing stimuli to a user while sensing the performance and condition of the user may rely on a controller for programmably coordinating a tracking device and a sensory interface device. The tracking device may be equipped with sensors for sensing position, displacement, motion, deflection, velocity, speed, temperature, humidity, heart rate, internal or external images, and the like. The sensory interface device may produce outputs presented as stimuli to a user. The sensory interface device may include one or more actuators for providing aural, optical, tactile, and electromuscular stimulation to a user. The controller, tracking device, and sensory interface device may all be microprocessor controlled for providing coordinated sensory perceptions of complex events.

U.S. Pat. No. 7,033,025 teaches an interactive occlusion system, including software and hardware, for the treatment of amblyopia using virtual reality or other physically interactive or perceptually immersive three-dimensional or two-dimensional computer generated simulations, in which the patient's occlusion compliance and usage time during occlusive and non-occlusive periods can be precisely recorded and the patient's visual acuity can be accurately measured to be provided to the clinician, as well as the capacity for entering prescriptions and treatment plans for individual patients and restricting individual access to that patient's prescription and treatment plan while allowing non-occlusive operation of the system after the prescribed occlusion time or for non-patient users.

US Patent Application No. 20040259688 teaches a device which allows for a full range of motions from a users upper and lower body for the purpose of enhancing a virtual simulation. The purpose of this device is to allow users to run both forward, backwards, and side-to-side, and to allow the user to jump, crouch, prone, twist and turn while remaining centered over a control pad. The devices supports the user via the user's back allowing the user to perform any of the mentioned movements without having to hold onto any means of support with their hands. Any of the user's movements can be superimposed into a virtual scenario such as a video game, tactical simulator, physical fitness training software, etc. The invention includes a vest that attaches to the base on the user's back. This vest is highly adjustable allowing for a snug fit on the user for stability. The base itself consists of a floor piece that not only interprets the users footsteps but also can be manipulated by software to simulate a wide variety of terrains. The second part of the base is the swing arm that translates the users orientation while keeping the user centered over the floor piece.

US Patent Application 20050009605 teaches image-based video game control devices. In one aspect, a device for controlling a video game includes an input, an imager, and a movement detector. The input has a movable reference surface. The imager is operable to capture images of the reference surface. The movement detector is operable to detect movement of the reference surface based on one or more comparisons between images of the reference surface captured by the imager and to generate output signals for controlling the video game based on the detected movement. In another aspect, a device for controlling a video game includes a movable input, an imager, and a movement detector. The imager is attached to the input and is operable to capture images of a scene in the vicinity of the input. The movement detector is operable to compute three-dimensional position coordinates for the input based at least in part on one or more comparisons between images of the scene captured by the imager and to generate output signals for controlling the video game based on the computed position coordinates.

Canadian Patent No. 2360051 teaches that “[p]ersons such as travellers in an airport are given an opportunity to remove themselves from being under suspicion of terrorism or the like. Persons are provided with one or more opportunities to reveal information about themselves by way of a personal disclosure that would normally be unacceptably invasive if such disclosure were mandatory. The nature of the personal disclosure is such that almost all persons frequently choose to make such a disclosure in their ordinary day-to-day lives, but would be offended if required to make the same disclosure. In one embodiment, persons are given an opportunity to use an airport lounge spa facility with separate showers, saunas, steam rooms, and whirlpool baths, for men and women. Clothing is safely held (and possibly inspected) by locker room attendants while patrons are using the spa. A method of cost management is provided, whereby the reduction in suspicion (by way of the personal disclosure) of the large numbers of people using the spa is translated into a cost savings in terms of underwriting insurance, or the like, whereby this cost savings funds the construction of the voluntary personal disclosure facility. In another embodiment patrons are offered a free medical exam or health diagnostic that includes a personal disclosure, such as undressing, being scanned, or the like. Other embodiments include an opportunity to play a free Virtual Reality (VR) game using VR goggles having a retinal scanner, or an opportunity to play a free video game by pressing a fingerprint scanner to generate a virtual world from a magnified video image of the participant's thumb.”

EPO Application No. JP2003000577820030114 teaches an event providing system server that transmits subject information to be executed by a user in the event with clue information for meeting with an actor staff to a user terminal, and also transmits transmission information to be transmitted to the user who accesses depending on the clue information to a staff terminal carried by the actor staff. The user acquires the transmission information from the actor staff and transmits it as report information to the event providing system server by use of the user terminal, whereby attaining the subject in the event. The presence of the actor staff who plays the role fitted to the event can bring about humaneness to the event provided by the event providing system server and make the virtual reality created by the event closer to the real world.

Mark Reaney, a professor at the University of Kansas, gave a talk entitled “Art in Real-Time: Theatre and Virtual Reality” to the Centre interdisciplinaire de recherche sur l'esthétique numérique in Paris, France. The following paragraphs are taken from the abstract of Professor Reaney's paper.
The art of the theatre has many similarities to the phenomenon of virtual reality. A theatre performance and a VR experience both are time based, existing only during that time that the human participants are engaged with them. Both rely on the creation of a fictive universe designed to entertain, inform, and enlighten.
At the University of Kansas a program of experiments spanning the past 8 years have explored virtual reality technologies as they can be applied to theatre production. Initially, a wide variety of VR systems were tested as tools for the traditional scenographer and number of productions were designed using these techniques. Later, a series of theatre pieces were produced using virtual reality as the scenographic medium. Real-time simulations coupled with live actors to form a new form of stagecraft.
The aim of VR/Theatre productions such as The Adding Machine, Wings, Tesla Electric and Machinal was to interface VR systems, live actors, and theatre audiences in such a way as to reveal the emotional context of these plays using dynamic, and ephemeral virtual scenery. Every production met this goal with alternating successes and disappointments, but always furthered the better understanding of both theatre and VR.

Marketer Christopher Ryan, in 2001, wrote a paper posted on www.allbusiness.com on “Virtual Reality in Marketing.” His introduction says:
Virtual reality marketing combines the powerful technologies of interactive marketing and virtual reality . . .

Maria Rousseau gave a paper at the Foundation of the Hellenic World in Athens, Greece, entitled “Incorporating Immersive Projection-based Virtual Reality in Public Spaces.” Her abstract is reproduced below.
As immersive virtual reality increases in popularity, a growing number of institutions incorporate projection-based display systems in their daily function. For the most part, these institutions operate in the academic, research, and industrial domains while the users of their virtual reality systems are specially trained staff members and researchers. There is, however, considerable interest in virtual reality applications on behalf of museums, educational organizations, the medical and corporate field, and the entertainment industry. This paper examines the issues involved in the deployment of immersive projection-based virtual reality technology in museums and other public spaces. Emphasis is placed on the challenges and pitfalls of incorporating immersive projection technology in settings such as the above, settings other than research laboratories or industrial research and development departments.

Karl Dohm and Gary Withrow believe that virtual reality offers the potential to enhance sports and fitness by creating realistic simulations and enhancing the experience of indoor exercise, and have written a paper to that effect.

There is an advertisement for 3-dimensional (virtual reality) gaming on www.download.com for a virtual reality Christmas:
3D gaming glasses were a big hit last Christmas and this Christmas things have just got better. Read more on this amazing new toy!
Dec. 1, 2003—3d-glasses.us is the place to review the very latest Virtual Reality toy available on the web. Experience the latest in virtual reality technology this Christmas with 3D images that float inside and outside of your monitor! Become immersed in unbelievably real 3D gaming, movie, internet, photo, and graphic environments as our patented stereoscopic 3D glasses instantly take you there. You have to see to believe—thrills guaranteed!
And, finally, there is a virtual tour service touting its wares on the web:
The future of virtual reality is firmly in the hands of the world of marketing and advertising. As technology evolves, hotels, shopping malls, parks, department stores, etc., that do not offer online virtual tours will fail to attract many qualified visitors who are using the Internet to search for products and services. Dynamic Digital Advertising (DDA) offers companies, who want the latest high-tech tools to market to potential customers, virtual reality tour services created by our skilled graphic designers and programmers.

Nowhere in the art have we found a mention of using a virtual reality system for crowd control or for alleviating the dullness of waiting or performing a sedentary activity. There is a need for such a use in long waiting lines such as those in amusement parks that can be hours long for popular rides in popular parks. There is also a need for such a use when performing sedentary, dull activities such as lying in a tanning booth or waiting for a store to open.

### BRIEF SUMMARY OF THE INVENTION

The present invention comprises the use of a portable virtual reality device that provides a simulation which, in one embodiment, may include a situation-compatible scenario, perhaps with paid advertising, comprising the use of commercially available virtual reality goggles and a commercially available earbud sound system while the user engages in an activity that may be considered boring and time-consuming, such as waiting in a line or lying in a tanning booth.

### BRIEF DESCRIPTION OF THE DRAWINGS

FIG. 1 shows a portable virtual reality device being worn by a user performing a sedentary activity.

FIG. 2 shows multiple portable virtual reality devices, one being worn by each user waiting in a line.

### DETAILED DESCRIPTION OF THE INVENTION

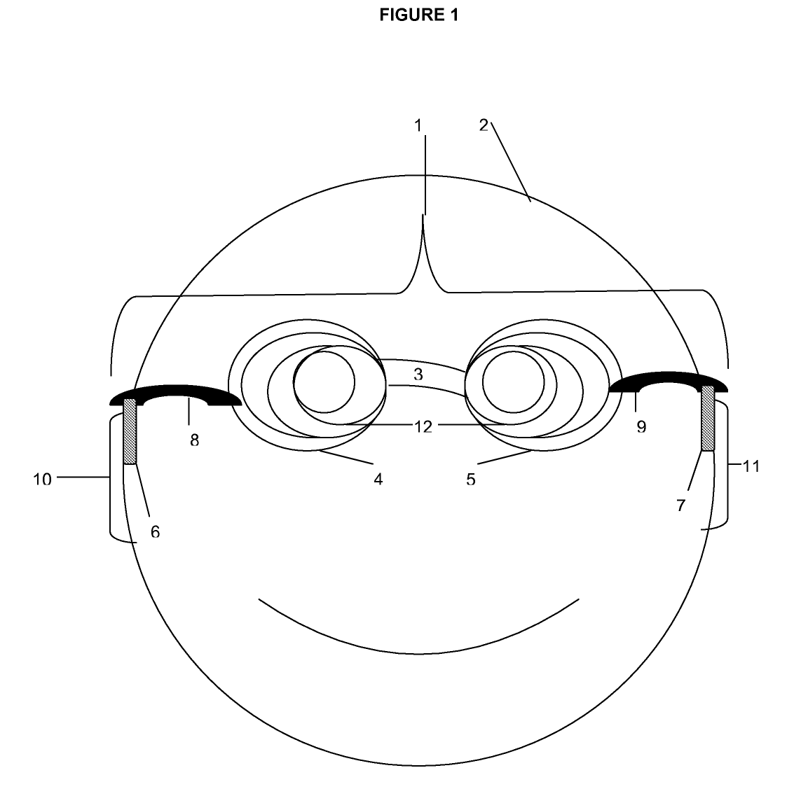

Referring now to FIG. 1, a depiction of a commercially available portable virtual reality device 1 is shown being worn by a person 2 who is performing a physically and mentally sedentary activity in actual reality. The portable virtual reality device 1 comprises a set of goggles 3. The goggles 3 comprise a left eyepiece 4 and a right eyepiece 5 and a left earphone 6 and right earphone 7, which may, in one embodiment, be a pair of earbuds (not shown) worn in the ears that may communicate with the virtual reality device using a wire between the earbuds and the virtual reality device or a wireless transmission device 13 or in another embodiment be a left 6 and right 7 earphone that are rotatingly attached to a left earpiece 8 and a right earpiece 9 such that the person 2 can adjust the earphones 6 and 7 for individual comfort, said earphones 6 and 7 being used to stereophonically or monaurally deliver sound to a person's 2 left ear 10 and right ear 11 which may be synchronously generated by a particular virtual reality scenario being played. Sound is not a required component of any virtual reality scenario within the scope of the invention herein described.

Each eyepiece 4 and 5 contains a mechanism 12 suitable for showing virtual reality scenarios such that the scenarios may appear to a person 2 who wears the goggles 3 to be in three dimensions. In one embodiment, this mechanism 14 may be turned on for three-dimensional presentation or off for two-dimensional presentation. In another embodiment, this mechanism is not switchable between two- and three-dimensional display.

The portable virtual reality device 1 is lightweight and can be adjusted to fit any person's head and eyes. It is relatively inexpensive to produce and can be used and reused in large crowds by each individual in that crowd.

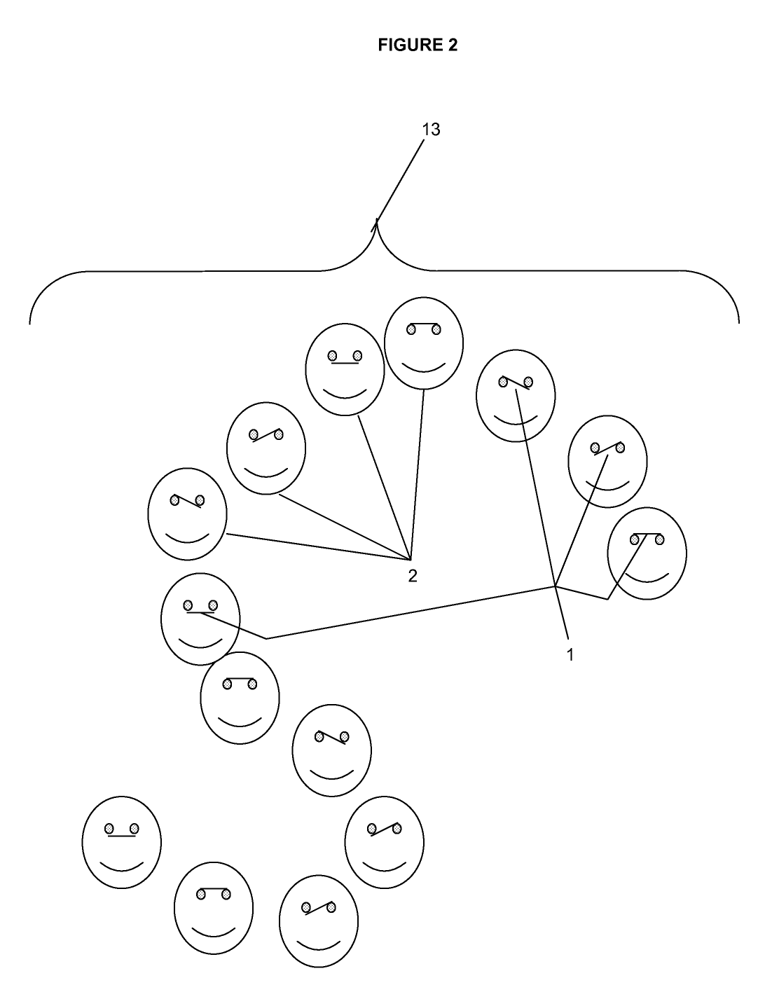

Referring now to FIG. 2, multiple portable virtual reality devices 1 are shown being worn by multiple persons 2 waiting in a line 13. The individual person 2 may or may not be able to choose the program displayed by the virtual reality device.

A plethora of possibilities exists for virtual reality scenarios that can be used to entertain and/or educate users while users are engaged in a physically and mentally sedentary activity. Educational examples include but are not limited to: show previews for upcoming shows (television, movie or live theatre) while the user waits in a ticket line; a short concert given by a musical performing group for use while the user waits in line to buy tickets for an event or concert performed by that musical group; a virtual tour of a store while waiting for the store to open; a virtual tour of potential vacation spots while waiting for a travel agent; a virtual high-school or college class review session to be attended at the student's convenience. Exciting, stimulating scenarios include but are not limited to: a virtual reality amusement park ride while waiting in line to ride that ride. Relaxing scenarios include but are not limited to: a virtual reality beach suitable for use while lying in a tanning booth. These are examples only; other scenarios can also be used within the scope of the invention while performing these or other sedentary activities. The scenario may, in one embodiment, be programmed by the user.

The virtual reality scenario may or may not contain paid advertising. Advertising may comprise a depiction of an advertisement within the scenario itself (such as text on a billboard within the virtual reality landscape, for example) or text overlaying the scenario in a manner similar to movie subtitles, for example.

While a preferred embodiment is shown and described herein, it should be understood that the present disclosure is made by way of example only and that variations in the described invention and its uses are possible within the scope of this disclosure without departing from the subject matter coming within the scope of claims to be examined, and a reasonable equivalency thereof, which I regard as my invention.

I claim:

1. A method of use for a commercially available portable virtual reality device comprising:
Use of a portable virtual reality device for entertainment by one or more persons who are in a mentally and physically sedentary setting; and
Use of a virtual reality scenario that is related to but more stimulating than a person's physical setting.

2. The method of claim 1 wherein said virtual reality scenario contains paid advertising.

3. The method of claim 2 wherein said virtual reality scenario advertising is displayed within the context of said virtual reality scenario.

4. The method of claim 2 wherein said virtual reality advertising is displayed as an overlay to said scenario.

5. The method of claim 4 wherein said overlay is text positioned in a place selected from the group consisting of a supertitle position, a subtitle position, and across the scenario itself.

6. The method of claim 1 wherein said virtual reality scenario is selected from the group consisting of educational, exciting, and relaxing.

7. The method of claim 1 wherein said virtual reality scenario is programmed by said person.

8. The method of claim 1 wherein sound is incorporated into said virtual reality scenario.

9. The method of claim 8 wherein said sound is played in a way selected from the group consisting of stereophonic and monaural.

10. The method of claim 1 wherein sound is not incorporated into said virtual reality scenario.

11. The method of claim 9 wherein said sound is delivered to the person using a sound system selected from the group consisting of earbuds plugged into said virtual reality device and speakers directly attached to said virtual reality device and located next to ears.

12. A method of use for a commercially available portable virtual reality device comprising:
Use of a portable virtual reality device for entertainment by one or more persons who are in a mentally and physically sedentary setting;
Use of a virtual reality scenario that is related to but more stimulating than a person's physical setting;
Use of a virtual reality scenario that incorporates paid advertising; and
Use of sound in a virtual reality scenario that is synchronized with a virtual reality scenario being presented.

13. The method of claim 12 wherein said virtual reality scenario advertising is displayed within the context of said virtual reality scenario.

14. The method of claim 12 wherein said virtual reality advertising is displayed in a way selected from the group consisting of supertitles, subtitles, and overlay to said scenario.

15. The method of claim 12 wherein said virtual reality scenario is selected from the set consisting of educational, exciting, and relaxing.

16. The method of claim 12 wherein said virtual reality scenario is programmed by said person.

17. A method of use for a commercially available portable virtual reality device comprising:
Use of a portable virtual reality device for entertainment by one or more persons who are in a mentally and physically sedentary setting;
Use of a virtual reality scenario that is related to but more stimulating than a person's physical setting;
Use of a virtual reality scenario that is selected from the group consisting of exciting scenarios, relaxing scenarios, and educational scenarios;
Use of a virtual reality scenario that incorporates paid advertising incorporated into said scenario as content within the scenario or as a method of display selected from the group consisting of supertitle, subtitle and overlay;
Use of sound in a virtual reality scenario that is synchronized with a virtual reality scenario being presented; and
Use of a sound system selected from the group consisting of earbuds and personal speakers attached directly to said virtual reality device.
